(19) United States
(12) Patent Application Publication
(10) Pub. No.: US 2016/0221843 A1
(43) Pub. Date: Aug. 4, 2016

(54) LIGHTWEIGHT MODULAR WATER PURIFICATION SYSTEM WITH RECONFIGURABLE PUMP POWER OPTIONS

(71) Applicant: TerraGroup Corporation, Allentown, PA (US)

(72) Inventors: Primo L. Acernese, Allentown, PA (US); James Novak, Emmaus, PA (US)

(21) Appl. No.: 15/099,062

(22) Filed: Apr. 14, 2016

Related U.S. Application Data
(63) Continuation of application No. 13/645,609, filed on Oct. 5, 2012, now abandoned.
Application No. 13/645,609 is a continuation-in-part of application No. 12/717,611, filed on Mar. 4, 2010, now Pat. No. 8,282,823.

(51) Int. Cl. C02F 1/44; B01D 61/02

(52) U.S. Cl. CPC C02F 1/441; B01D 61/025; B01D 2317/04; B01D 2313/19; B01D 2313/243; C02F 2201/008; C02F 2201/007; C02F 2103/08

(57) ABSTRACT

A modular water purification system has a high pressure pump interchangeably received into one of two or more alternative power modules that can rely on different energy sources, such as an combustion engine module or an electric motor module. The pump applies water pressure to a reverse osmosis filter element. The system is reconfigurable for a given deployment, such as with a higher pressure pump operation for a high dissolved solute concentration, such as sea water desalination, or at a lower pressure for fresh water. Modules for deploying parallel paths each having a high pressure pump and reverse osmosis filter can be supplied as an addendum, or included in the supplied unit. The supplied unit is dimensioned so that the modules are stackable atop one another and in abutment to fill out a rectilinear volume on a pallet.

### CROSS REFERENCE TO RELATED APPLICATION

This application is a continuation-in-part of pending U.S. patent application Ser. No. 12/717,611, filed Mar. 4, 2010, US patent.

### BACKGROUND

This disclosure concerns field-deployed water purification systems, especially for military use, disaster relief and other situations requiring a set of elements scaled for the particular application to be readily transported, set up and operated to produce purified potable water from unqualified water sources.

As disclosed, for example, in U.S. Pat. Nos. 5,972,216 and 5,788,858, which are hereby incorporated by reference, it is known to deploy a modular water purification system having pump elements, filter elements, storage tanks and the like. The modular elements can be wholly or partly mounted on trucks or trailers, or can be discrete units that are carried as cargo to a site where needed to produce potable water. Potable water might be obtained by purifying water from any of various sources, such as water from a natural watercourse such as a creek or river. Sea water is a source from which water can be desalinated by appropriate filtration techniques. Water also may be extracted and purified from sources that might have been considered acceptable but are contaminated or might be contaminated such as flooded municipal water supplies or swimming pools. Water also might be filtered because it originates in a source that might be vulnerable to introduction of foreign materials such as pathogens, or to sabotage.

Water treatment in such situations comprises plural filtration steps. Solid material such as entrained silt and algae is separated by screening, settling, centrifugal motion, etc. Chemical fractions that may be in solution or entrained are absorbed, for example by chemical reaction producing a precipitate that is separated out or by exposure to a reactive surface at which the chemical fraction is immobilized. Water may be subjected to ion release materials such as copper, silver and other biocidal materials.

It would be advantageous to provide a water treatment system that is sufficiently versatile to be configured and reconfigured conveniently to meet a variety of deployments situations. Although one might equip and scale a portable water treatment facility for predefined conditions, it is not possible to know the specific conditions in which potable water may be required on short notice, for example in cases of disaster relief or military deployment in widely differing conditions and geographic locations. In such applications, it would not be practical to build many different types of portable water treatment facilities that are designed specifically and optimized for certain conditions. A standardized system is needed that can serve a range of conditions.

In order to outfit a standardized system for conditions that are very different, one could provide in the system individual components that are optimized for the different conditions. For example, a standardized water purification unit could include an array of different filters or pump arrangements that might be selected from alternatives that are provided in the unit as shipped, some parts apt for desalination and others for fresh water treatment; some parts apt for a wilderness setting and others for urban deployment. However such a system is loaded with redundancy. What is needed is a standardized arrangement that can be shipped substantially complete in a unit that operators can configure and reconfigure in view of requirements such as alternative sources of raw water, a range of flow rate requirements, different available sources of power, more or less trained manpower being available to maintain and service the system in operation, etc.

### SUMMARY OF THE INVENTION

A configuration for such systems is disclosed wherein a demountable and re-mountable high pressure water pump for a reverse osmosis filter unit is selectively driven by one of two or more motors or engines. The motors or engines can be of the same sort or can be of different sorts, such as a diesel engine plus an electric motor, a gasoline engine, a hydraulic take-off or the like, or with two or more diesels, motors or engines in use. The power units are carried on respective framed modules and can be coupled interchangeably with a high pressure water pump having an enclosing holder that mates with the selected power unit via a docking arrangement that operationally couples the water pump to the motor or engine, and clamps the holder for the water pump to the power unit module frame for quick exchanges.

In another aspect, the system is supplied with low pressure feed and preliminary filter elements scaled with capacity sufficient to serve different reverse osmosis high pressure configurations, including a configuration with one high pressure reverse osmosis path and a configuration with plural reverse osmosis paths. In the plural path arrangement, each path or leg employs a power module driving a high pressure pump feeding water to a reverse osmosis filter module.

According to a further aspect, the system modules are carried in rectangular frames that when abutted against one another and stacked, form a rectilinear block. The stacked block of modules fits on a pallet by which the system can be shipped in a compact form.

The water can be passed through a reverse osmosis filter stage to remove ions, microbes and particles down to a very small size. Based on the proportion of dissolved solids in the source water, a higher or lower water pressure must be applied against the reverse osmosis filter membrane in order to achieve a given rate of filtered water throughput. For example, fresh water from a clear stream might be filtered with a 200 psi pressure differential across a given reverse osmosis membrane, whereas sea water might require 1,000 psi to obtain a similar flow rate.

There is typically an ample supply of feed water at the source. However, each of the elements of the water purification system (such as pumps, conduits, valves, solid separator units, filters and treatment elements, tanks and their connections, etc.) have pressure and flow rate characteristics. Other things being equal, an increased pressure differential across an element results in increased flow rate through the element. Flow resistance may be reduced by increasing the cross sectional area of flow or by inserting parallel elements, leading to an increased flow rate and/or a decreased pressure drop. Assuming there is no accumulator, elements that are serially connected to one another operate at the same flow rate. And when coupled to the same source of pressure head, the pressure head is distributed as pressure drops along each of the serially connected elements. Thus, designing a water purification system amounts to sizing elements and connecting them in serial and parallel arrangements to operate at an efficient point in their pressure/flow characteristic, and together to provide the desired flow rate.

In a military deployment or a disaster relief situation, the source of the supply water might have dissolved solids in a wide range, thereby presenting a range of filtration and/or treatment requirements. There might be a need for more or less potable water, for example due to the number and nature of persons who are to be supplied. (A military service member might be allotted 6 to 8 gal. per day, for example.)

The final product can be chlorinated and may be dispensed directly from an output or stored, for example in tanks or inflatable bladders from which the now potable water is dispensed. Advantageously, these different filtration and treatment steps are accomplished by pumping water obtained from a source, through successive treatment steps that are accomplished at modular pump, filtration, treatment and storage modules coupled by appropriate conduits, fittings and control valves.

The modules can be stages of processing in a self-contained water treatment system, but a more versatile and readily serviceable system is provided by a system wherein the stages are substantially separated into discrete modular parts that can be used or not used when required, and coupled in different configurations for different purposes. For example, to serve capacity requirements, it may be necessary to provide conduits, pumps and filtration media defining parallel flowpaths to multiply the flow capacity that would be available with single flowpath. Different configurations and filtration steps may be appropriate for different needs. For example, treating muddy fresh water may require separation of particulates more than other steps. Treating clear sea water may require desalination more than particular separation. It is useful to provide modules with connections enabling different deployments and configurations.

Filtration media may be disposed in filter cartridges that are useful for some nominal flow volume that is a function of the characteristics of the raw water being treated, after which the cartridges need to be replaced. To accommodate different flow arrangements and to enable the elements at respective operating stages to be switched in and out, arranged in alternative flowpaths and generally configured for needs at the time, the above-cited U.S. Pat. Nos. 5,972,216 and 5,788,858 provide for modular arrangements wherein operating elements such as pumps, separators, tanks and filters are connected on site according to alternative operational requirements.

Filtration systems that employ reverse osmosis water purification elements, for example for desalination, have pumping pressure requirements that are generally higher than might be required simply to move water from a raw water source through a separator and into a tank. Initial raw water collection, solids screening and passing of the water through filtration media are done at relatively low water pressure. A pump that moves water through a reverse osmosis filter stage needs to apply a pressure differential across the reverse osmosis membrane that is sufficient to overcome the tendency of water to diffuse through the membrane toward the side with a greater ion density. For desalination, the pressure differential enables pure water to diffuse to the low pressure side, leaving the higher salinity brine behind on the high pressure side, to be flushed away. Assuming that a given flow rate is obtained by providing a predetermined membrane surface area, the flow rate can be increased by adding reverse osmosis filter stages in parallel.

The various alternative configurations are such that quick connect couplings are advantageous. Multiple pump modules that respectively operate at high or low pressure need to be available. High and low pressure conduits and fittings need to be organized. Appropriate manifolds and various valves are useful for switching and flowpath diversion as needed.

Field deployed potable water sources are more efficient than transporting purified water to a site of need whenever the need for water exceeds a short time. Field water purification units are useful for military force deployment, disaster relief and other situations in which a temporary need arises and municipal sources are not available. Water treatment facilities may be carried on trucks or trailers and used to fill tanks carried on trucks or trailers, but so long as the facilities are needed at a certain location, mobility is not a requirement. Field deployment can be provided using modular elements packaged to be transported to a site and dropped off. The modular elements are sized to weight specifications enabling manipulation of the elements by a few soldiers or other workers. For example, if an assembled set of water treatment modules are dropped near a raw water source, and no single module weighs more than about 200 lbs. (about hundred kilograms), two soldiers working together can configure a water treatment plant on the same day, producing potable water sufficient to serve a company of soldiers.

A water treatment system divided into relatively small elements has the potential benefit that each discrete element can be made light in weight and is easier to handle or requires fewer people than a heavier element. If there are numerous modules that can be mixed and matched and coupled in different ways, the water treatment system may be more versatile, but configuring and connecting the modular parts is complex. It would be beneficial to maximize versatility, minimize individual module weight and to make the configuration and connection of an operable system uncomplicated.

The present disclosure addresses the nature and configuration of power sources used to operate the water purification system, i.e., the water pumps. Suction and pressure lines are required to draw in raw water, to establish a pressure differential across filter media, and to provide a head of pressure and/or to lift the elevation of water to be dispensed. The necessary pumps can be driven by electric motors if there is a source of electric power, which is advantageously quiet. Pumps can be driven directly by internal combustion engines. Pumps can be driven by electric motors that are powered from a generator driven from an internal combustion engine. These and other configurations are possible.

For military applications, an internal combustion engine may be desirable so as to operate independently, but an electric motor quieter and relatively maintenance free if a source of electric power is available. Some military vehicles provide for electric power take off from a generator coupled to the vehicle power plant. On the other hand, an electric motor is typically heavier than an internal combustion engine that develops a comparable power level. It is an aspect of the present disclosure to provide the capability of using either or both of electric motors and internal combustion engines in a modular water purification system, and to do so in a way that minimizes the weight of the modular components while at the same time reducing the complexity required to couple and decouple certain water pumps.

It is an object of the present disclosure to provide an optimized arrangement with respect to versatility and function in a configuration of light weight modules, by arranging for one or more pump components, especially the high pressure pump of a reverse osmosis water purification stage, to be interchangeably mounted in alternative prime mover modules having pump docking stations. A docking structure is provided on the pump. Each of the prime mover modules that may be employed has a complementary docking structure that receives the docking structure of the pump. When the pump is docked, the driven shaft of the pump is arranged by the docking structures to engage the driving shaft of the prime mover module, such as an internal combustion engine module providing mechanical power independently, an electric motor module providing mechanical power in conjunction with a generator or an available hookup to utility mains, a hydraulic pump or the like. The necessary mechanical connection of the pump to the source of torque is provided simply by inserting the pump housing into the docking station and clamping the pump housing in a docked position.

In embodying the arrangements described, a standardized base panel is provided on each of the alternative prime mover modules, in each case carrying the prime mover motor/engine and the docking station that locates the pump to engage precisely with the prime mover. Axially engageable rotational shaft couplings can be used for this purpose. The shaft coupler can comprise non-round and/or round male and female structures that engage and disengage axially and when engaged become rotationally fixed to one another. An example is a jaw coupler having circumferentially-spaced axially-extending fingers that interleave with one another and a vibration cushioning spider. Another example has axially protruding radially spaced fingers on a coupler on one shaft that fit into complementary finger sockets in the coupler on the other shaft.

The pump housing is preferably mounted in an assembly that forms a unitary chassis, in particular a cage attached around the pump housing between end plates that are affixed to one another and to the pump housing at the base plate and provide elongated bars that are useful as handles when manually placing and attaching the pump in position to engage the prime mover. Placing and attaching the pump involves sliding a shoe part of the pump assembly into a receiving slide on the base panel of the prime mover module, and clamping the shoe against the base panel by tightening down bolts on the receiving slide.

More particularly, a water purification system is provided with multiple functional modules that are connectable by water flow conduits, one or more including a water filtration element and one or more including a water pump. The water flow pump is detachable and demountable from drive units to which the pump can be coupled selectively, for example with one or more drive units being provided with an electric motor prime mover and another of the drive unites having an internal combustion engine. The system is configured for convenient re-mounting of the pump to a different one of the modules, of the same or different type of drive unit, to which the pump can be coupled. The electric motor and internal combustion engines preferably have their own modules, either or both of which may be available in a given deployment of the water purification system, and to which the respective electric motor or internal combustion engine or other prime mover such as a hydraulic drive unit can be coupled. The pump is mounted upon and driven by either of the module prime movers as the power source.

The multiple functional elements can be configured such that individual modules are limited to particular functions. In addition to the modules providing mechanical power in the form of torque to the pump shaft, the modules can include a solids separation module, one or more additional modules that might or might not have detachable aspects but likewise pump water, tanks or bladders for collection of raw or treated water, media filter elements and chlorinators. Advantageously, the system includes a reverse osmosis filter stage and the demountable pump comprising a high pressure pump that develops a sufficient pressure head for water purification in demanding applications such as desalination of sea water. Tanks, storage bladders, intake elements and output nozzles are included and preferably the entire system is packaged as a set of framed modular elements that can be stacked together with one another and optionally a container of hoses, tools and supplies, so as to be readily dropped off on site and manipulated there using the elements provided, to supply potable water.

The water purification system modules preferably include at least one filtration module and at least two pump driving modules. At least one of the pump driving is used at any given time to drive a pump that is detachably mountable in the pump driving module, and likewise interchangeably can be demounted and reinstalled interchangeably in a different one of the pump driving modules. The supplied system also may be provided with one or more additional demountable pumps, making it possible when desirable to mount and run pumps in both pump drive modules using plural pumps. Inasmuch as pumps according to a standardized configuration can be interchangeably driven by prime mover modules that respectively may include an electric motor, an internal combustion engine, another power source or actuator, or a combination, the system can be driven independently or from an electric power source such as a utility power mains or a generator as another module or as an electric power take off from a vehicle power supply such as an on-board generator on a military vehicle. Alternatively or in addition to switching a pump to the most desirable one of plural available prime movers, additional pumps can be coupled to increase capacity, and any combination of pumps and prime movers can be employed.

Preferably, two pump driving modules are made available (although both might not always need to be deployed at a given site). The available modules include alternative prime mover modules, preferably the module carrying the electric motor and the module carrying the internal combustion engine. Each such pump driving module comprises a permanently installed prime mover (one of the motor or engine), with a detachable demountable fixture that can receive the water pump, enabling the pump to be swapped between and interchangeably to be driven by one of the motor and the engine (or interchangeably swapped between two modules both having electric motors or two modules both having internal combustion engines). All that is necessary is to install the pump using its standardized detachable mounting, by placing and affixing it in the complementary receiving structure of the module carrying the respective one of the motor and engine.

The modules are particularly useful in connection with modular water purification systems having one or more filtration elements with reverse osmosis filter membranes. In that case, a high pressure pump is needed to develop operational pressure for maintaining a flow through the membrane. A positive displacement high pressure pump of suitable capacity can be heavy, e.g., up to 160 lbs. A prime mover such as an internal combustion engine or electric motor of five or ten horsepower is also relatively heavy, e.g., 200 lbs. If permanently married in a pump module including a pump and motor/engine, the pump module would tax the ability of two persons to move and deploy it. By providing a detachable and re-mountable high pressure pump, not only is the module weight reduced to a more manageable level, but the versatility of the system is substantially improved.

The pump is arranged as an assembly with a cage or chassis that encloses around and protects the pump. The pump assembly is a unitary structure enabling the pump to be manipulated into and out of the prime mover module. In one embodiment, the pump assembly comprises the pump housing, end plates that are bolted to the pump housing and extend from the pump housing, bars that serve as handles and extend between the end plate, and a sliding shoe attached to the pump housing. The sliding shoe is disposed under the pump housing and has lateral flanges that mate with a slide fixture of the pump driving module carrying the prior mover. The end plates and chassis protect the pump housing, afford for manual manipulation, standardize the mounting structure, and dissipate heat that may be generated by operation of the pump. The sliding shoe is received in the slide fixture of the driving module and affixed in place by clamps engaging against the lateral flanges of the sliding shoe.

The pump assembly and pump driving prime mover rest on a base panel on the pump driving module when mounted. The slide shoe of the pump assembly slides in a direction parallel to the pump shaft axis, into a guiding receptacle affixed to the base panel. The guiding receptacle can have spaced flanges shaped to overlap the lateral edges or flanges of the slide shoe. The clamp structure mechanically fixes the slide shoe to the base panel at an axially advanced position at which the shaft couplings of the pump and the engine or motor become operatively engaged. The end position can be set using locating pins or detents or in the embodiment shown in the drawings, by an end block. In the exemplary embodiment, the spaced flanges on the base panel can be clamped down on the shoe, but it is also possible to provide an arrangement wherein other particular provisions, such as the opposite gender relationship is used for the clamped and clamping parts, or the shoe could be bolted directly to the base panel.

According to another aspect, a set of modular units is provided in one or more particular sets of elements. In one set of supplied modules in a system, there are at least two power modules that can be selected alternatively to drive a high pressure pump applying pressurized water to a reverse osmosis filter module. By outfitting a modular system shipped as a unit, with one high pressure pump and two or more power modules, preferably relying on different sources of energy, as electric or hydraulic motors, diesel or gasoline internal combustion engines, the water purification system can operate using available energy selected on the spot.

According to another embodiment, modular units selected for shipment are sized to fit in an arrangement of stacked and abutted framed modules that complement one another when stacked so that the system as shipped forms a rectilinear unit, especially a rectilinear, optionally cubic volume with a footprint that matches a shipping pallet. The modules are stacked and attached to one another and the pallet for shipping.

The supplied system can have one additional high pressure pump and one additional reverse osmosis filter element that fit into the rectilinear stack, or the extra pump and filter can be made available as a supplemental kit. This allows two power modules (which may rely on the same type of energy source or different types) to be operated concurrently. In such an arrangement, upstream modular elements sized to provide the downstream flow rate needed, it is possible to substantially double the flow rate of a modular water purification system by adding only a parallel second reserve osmosis filtration path to a basic system of upstream pumps and filters that supply and remove un-dissolved solids. This is possible because the reverse osmosis filter with its requirements for high differential pressure presents the most resistance to flow along the filtration flow path. Doubling (or otherwise multiplying) only the reverse osmosis leg or legs provides the capability to likewise multiply (to double or nearly double) the flow rate of purified water, without the need to likewise multiply all of the upstream elements of the water purification system.

A number of additional objects and aspects of the system will be seen from the following discussion of specific exemplary arrangements that are advantageous for reasons that are explained or will become apparent.

### BRIEF DESCRIPTION

The description and drawings demonstrate certain examples in connection disclosure of general aspects and also specific embodiments. The subject matter should not be regarded as limited to the alternatives and embodiments used as examples. Instead, reference should be made to the appended claims to assess the scope of the subject matter. In the drawings,

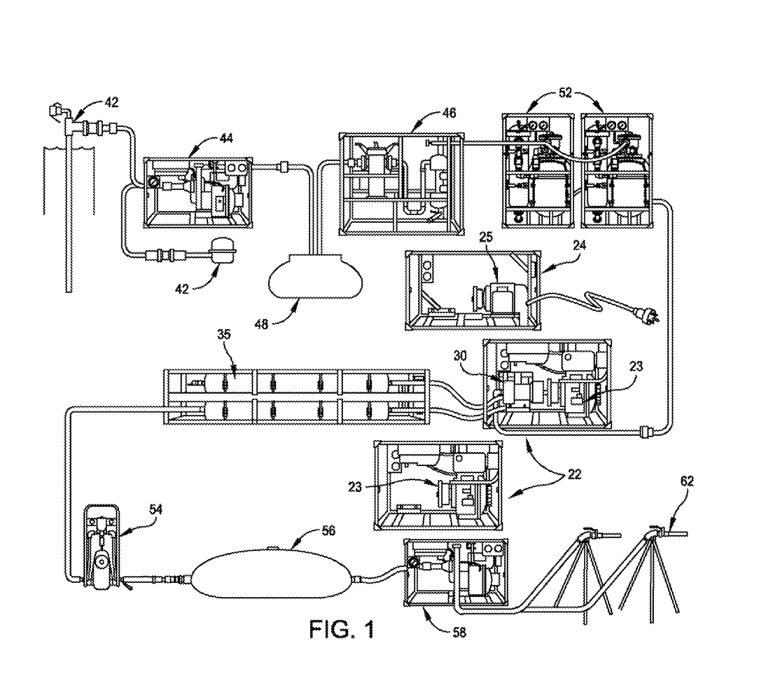

FIG. 1 is a schematic illustration of a water treatment system according to one embodiment, having an electric motor drive unit and an internal combustion engine drive unit, either of which can alternatively receive a pump.

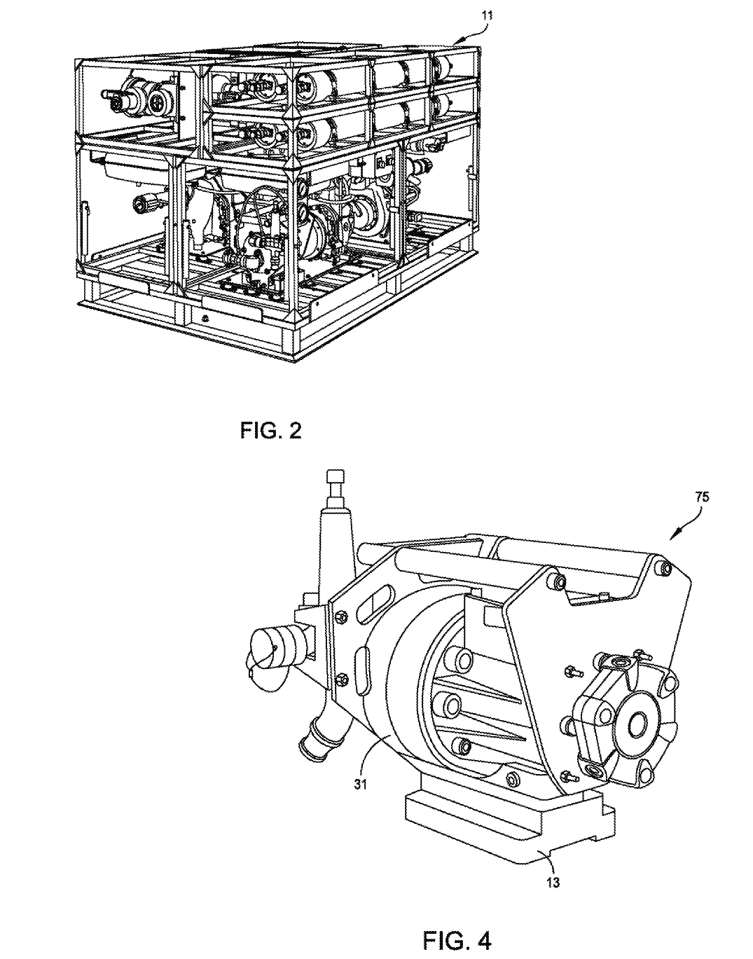

FIG. 2 is a perspective view showing the water treatment system with modules that are sized to stack into a regular rectangular shape transport as a palletized load.

FIG. 3, is an exploded view showing mounting and coupling fixtures that are coupled to the pump housing for mounting the pump in a selected one of the drive units.

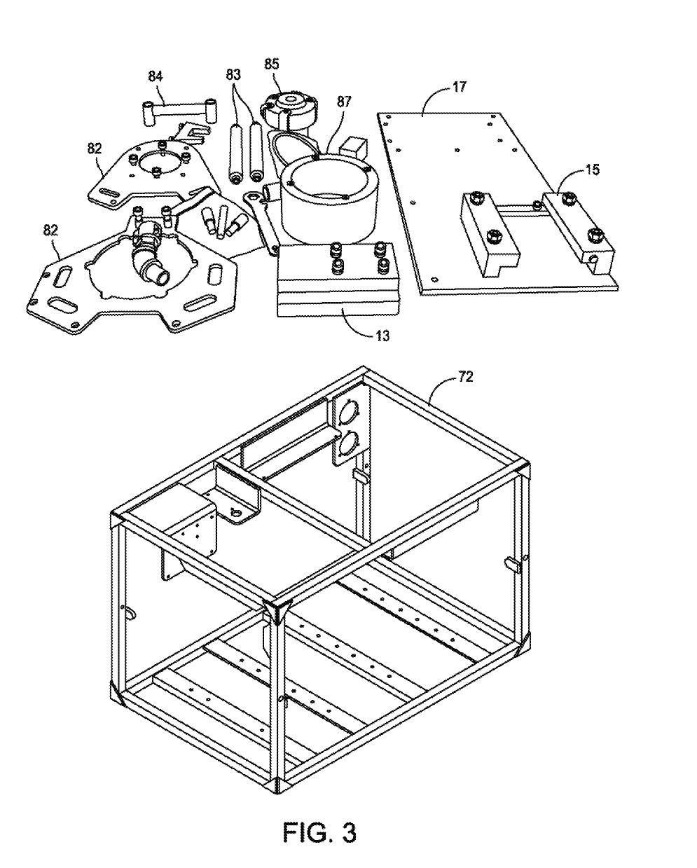

FIG. 4 is a perspective view showing a pump assembly from one end, as configured for removable mounting in the selected drive unit.

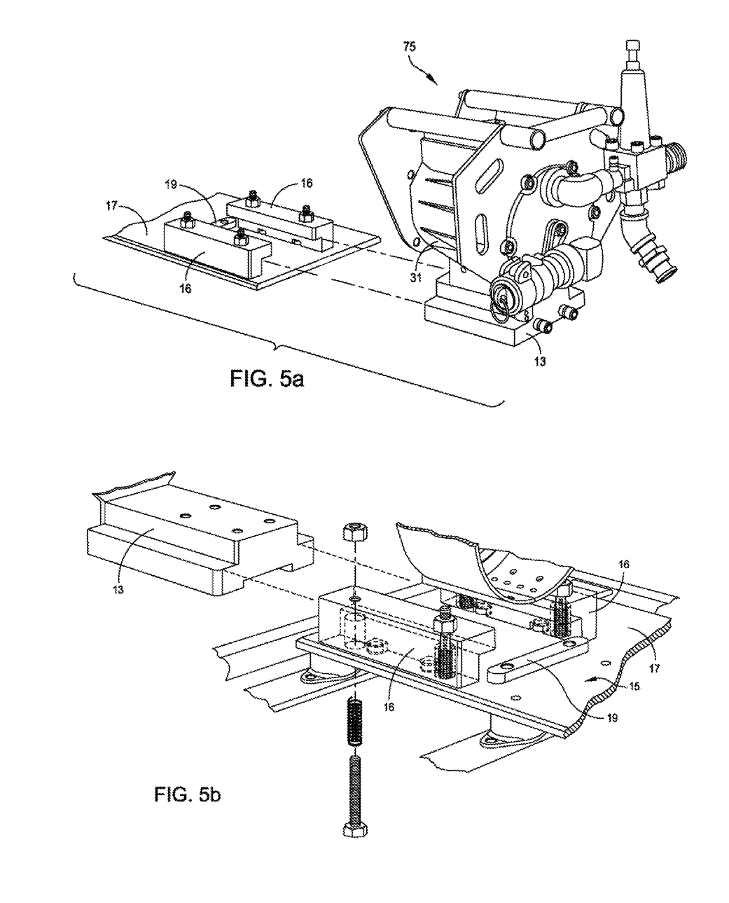

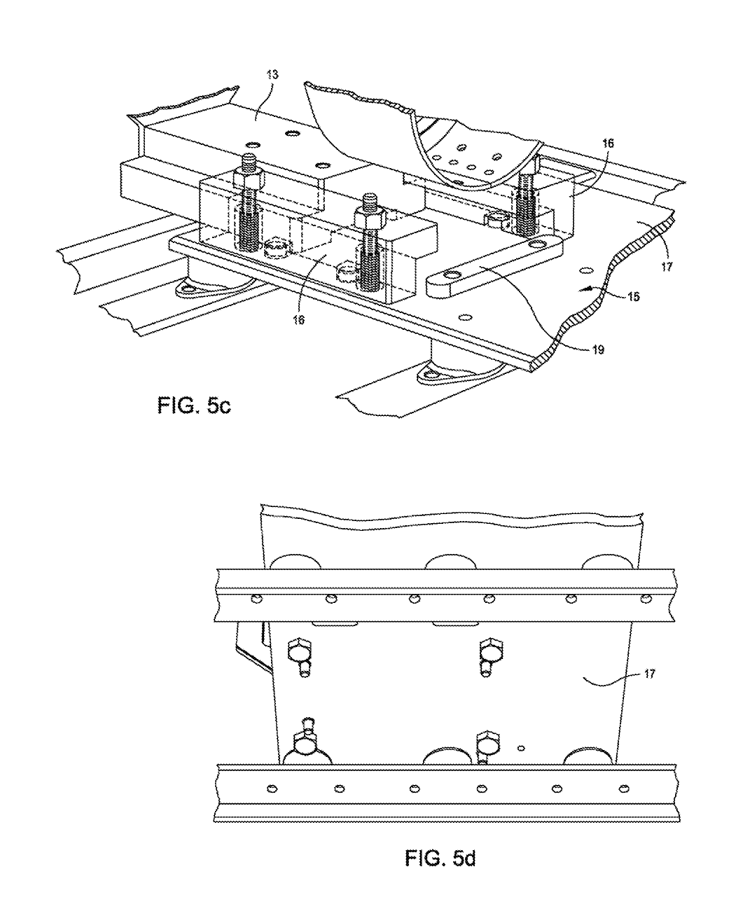

FIGS. 5a through 5d are perspective views showing the pump assembly from the other end, and including schematic illustrations showing how the pump assembly interacts with the receiving structure mounted on a base panel of the drive unit.

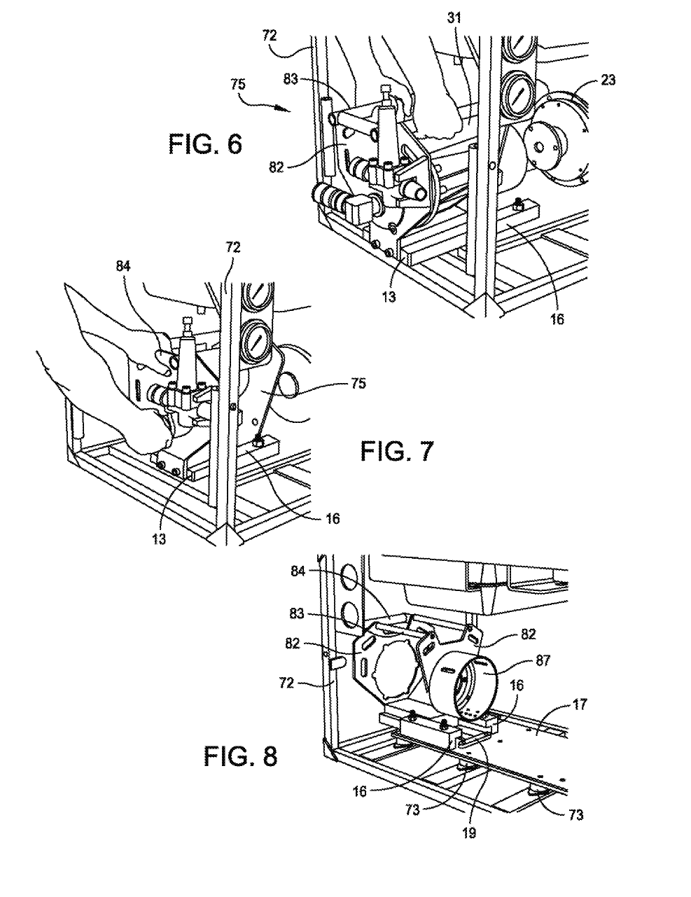

FIG. 6 is a perspective illustration showing the pump assembly and drive unit during a phase of assembly wherein the pump assembly is being manually moved into position or out of position.

FIG. 7 is a perspective illustration as in FIG. 6, with the pump assembly near its mounted position.

FIG. 8 is a partial perspective view showing the relationship between the chassis part of the pump assembly (without the pump housing itself) and the clamping slide receptacle on the base panel, and without the prime mover motor/engine being shown.

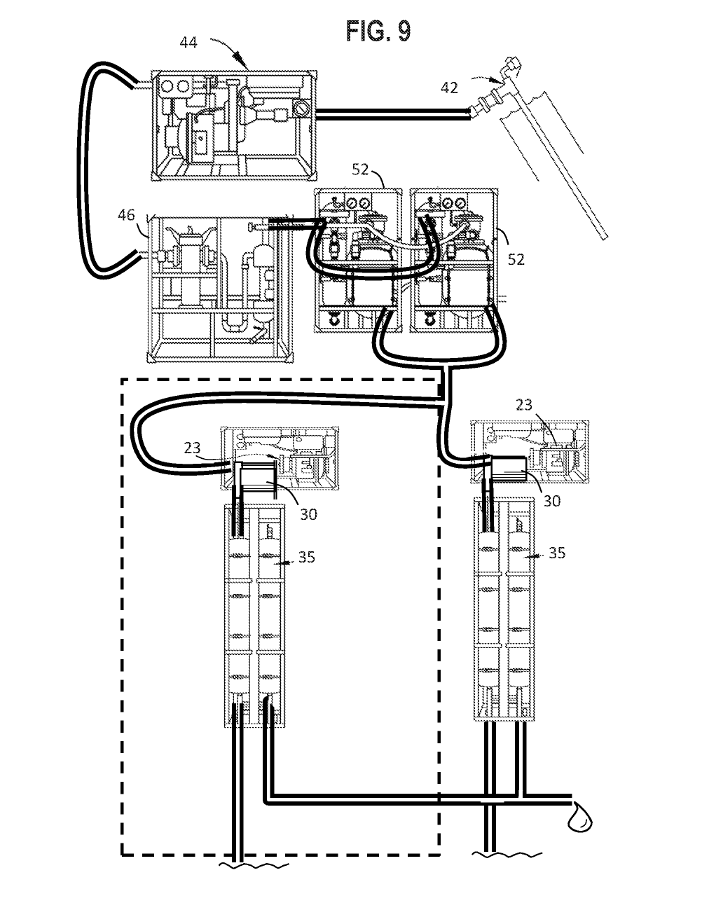

FIG. 9 is an assembly view showing an embodiment configured as described, except at least one additional reverse osmosis water purification path is provided, such that two reverse osmosis outlet paths are operated in parallel, both fed from a low pressure raw water upstream supply. The modular elements as shown can be supplied as a reconfigurable unit, or the additional pump and reverse osmosis filter unit can be provided as an add-on unit supplied separately.

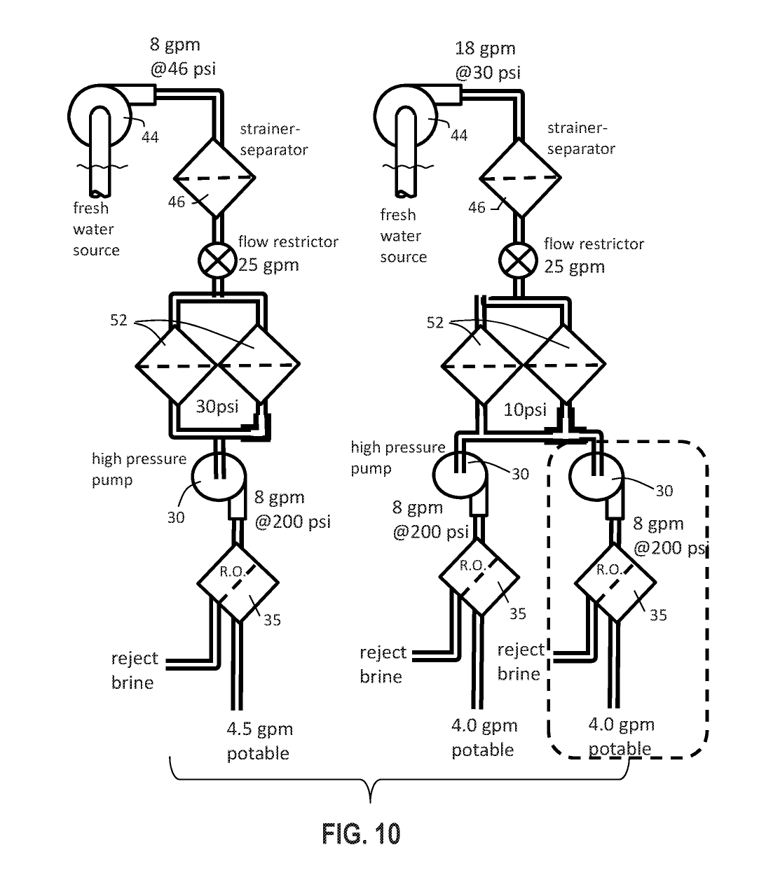

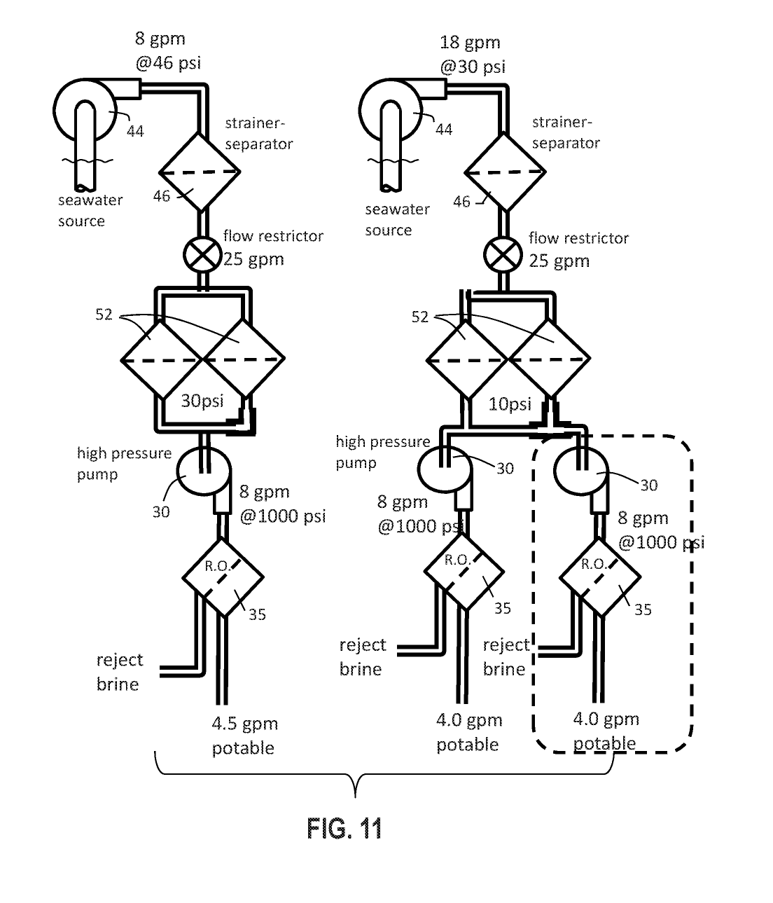

FIG. 10 is a diagram comparing typical flow conditions that can be achieved by multiplying the flow paths provided only in the high pressure pump and reverse osmosis filter section of the water purification system. This example shows conditions typical of fresh water purification.

FIG. 11 is a comparative diagram comparable to FIG. 10, except that this example shows conditions typical of purification of sea water.

### DETAILED DESCRIPTION

FIG. 1 shows a water purification system according to an exemplary embodiment having plural functional modules connectable by water flow conduits, the modules carrying at least one water filtration element, and at least one water pump coupled by the conduits to the water filtration element. One of the water pumps, namely high pressure pump 30 is configured in this embodiment to permit coupling of the water pump 30 to a selected one of at least two alternative drive units 22, 24 exemplified in the depicted example by a drive unit 24 with an electric motor 25 and one or more internal combustion engine drive units 22 with internal combustion engines 23.

The prime movers of the drive units, namely the electric motor 25 and the internal combustion engine 23, are permanently mounted in the frame structures that are structured to support the respective drive unit. Thus, for example, the internal combustion engine drive unit 22 can have a diesel and/or gasoline engine 23 and those conveniences or necessities that are applicable to a combustion engine, such as a fuel tank, a battery, an electric heater, etc. Likewise, the electric motor drive unit 24 includes in addition to the electric motor 25, the necessary connections for coupling the motor to a source of electric power and may have switches and circuit breakers to facilitate connection. In the embodiment shown, the electric motor is shown for purposes of illustration of an exemplary connection, with a standardized AC plug that might be used for connecting to an electric utility system or to a generator (not shown).

Preferably the respective module frame are parts of a unit 11 that can be stacked into a palletized package as shown in FIG. 2, wherein each frame occupies a segment of a regular volume capable of being strapped as a unit for convenient shipping, manipulation by fork truck or other load device, deployment via air drop or other appropriate handling.

An aspect of the system is that at least one available water pump 30 is alternatively coupled to a selected one of two or more drive units 22, 24 that are both configured to receive the pump 30 interchangeably, instead of having the pump installed as a permanent element in the drive unit. In order to facilitate this aspect, the water pump 30 is part of an assembly that is configured for manual handling, namely for removing the water pump from one drive unit and installing the water pump in another drive unit that may be of the same or different prime mover type, i.e., it may use the same or a different source of energy. Parts of the pump assembly are shown separately in FIG. 3 and assembled with the pump housing in FIG. 4.

In FIG. 1, three drive units are provided and can power the water pump 30 that provides high pressure water to the reverse osmosis filter module 35 using different sources of energy. The three units shown in this example include two internal combustion engine modules 23, one of which is connected to the high pressure pump 30. In embodiments shown and described below, it is possible to employ two reverses osmosis legs in parallel, each having a high pressure pump 30 driven by one of the power modules and each pump 30 applying water pressure to a reverse osmosis filter module (only one such leg being shown in FIG. 1).

The pump assembly has a shoe 13 (the pump base) to which the pump housing (the pump) 31 is bolted or otherwise attached. The shoe 13 or base for the pump assembly has laterally protruding flanges that fit into a slide 15 on a base panel 17 provided in the drive units. The slide on the base panel 17 can be formed by parallel angle bars forming a right angle in cross section. Preferably the slide 15 is formed by continuous bars as shown, leading up to an end stop 19 in the axial direction, but could comprise a set of separate spaced hold-downs. The angle bars in the embodiment shown are parallel and spaced apart, and provide free edges 16 that are located at a standoff space above the surface of the base panel 17 sufficient, when not bolted down tightly, to admit and rest over the lateral edges of the shoe 13. The angle bars form a locating slide and overlie the edges of the shoe 13 so that when the angle bars are bolted tightly down against the mounting panel 17, the pump assembly is securely and rigidly affixed on the base panel 17 in proper position, by clamping of the base shoe against the mounting panel by the bolted down angle bars. The stop 19 that defines the point of maximum advance into the slide provided on the mounting panel between the parallel bars at which the shaft couplings of the prime mover drive shaft and the driven pump shaft are operationally engaged. Advantageously one or more pivoting dogs (not shown) can be moved into place to prevent the pump assembly from being withdrawn until the dogs are pivoted of the retraction path of the pump assembly.

The prime mover, such as a diesel or gasoline internal combustion engine, an electric motor, a hydraulic motor or the like, is also fixed relative to the mounting plate 17 and has a drive shaft with the coupling positioned to engage a complementary coupling on the pump shaft. Thus the water pump can be installed on and driven by different power supplying frame units as appropriate for a given situation. The unused alternative prime mover power units, without a currently installed pump, are not as heavy as comparable units with permanently installed pumps. Swapping the pump from one prime mover to another and making the necessary water line connections is less complicated than bringing in a whole new pump unit that is permanently installed on a prime mover frame, and then making the water line connections needed.

FIG. 1 schematically illustrates a deployed water purification system, equipped as detailed herein with alternative power supplying frame units 22 driven by internal combustion engines 23, and a power supplying frame unit 24 driven by an electric motor 25. The associated water pump 30 is shown installed on one of the available internal combustion units 22, but is readily removable from that unit for alternative installation in the electrically driven unit 24 or in another similar internal combustion unit 22.

Advantageously, the water pump 30 that is alternatively driven by one or another of the power units 22, 24, is the high pressure water pump that is coupled to a reverse osmosis filter element 35. The respective elements of the water purification system include one or more inlet devices 42 coupled to a low pressure pump 44 that feeds raw water to a solids separator 46, optionally by way of a raw water storage tank or bladder 48. Removed solids are flushed away. The water is passed through one or more filtration units that carry cartridges containing filter media to which the water is exposed in known manner.

The water is then coupled through the high pressure pump 30 to the reverse osmosis filter 35. A sufficient head or differential pressure is needed on the membrane to oppose the osmotic pressure that would normally cause the water to diffuse toward the side with greater ion concentration, e.g., greater salinity. The high pressure pump operates to maintain sufficient pressure to oppose osmotic pressure and cause water to diffuse through the membrane toward the low ion concentration side, leaving ions behind on the so-called brine side. The high pressure pump also provides pressure and flow to force the progressively more brine-concentrated water on the brine side along a flow path through the filter element, with the salinity or other ion concentration becoming progressively higher, until the brine side water is discharged, e.g., flushed away or returned to the raw water source. The filtered output of the reverse osmosis filter is optionally chlorinated at chlorination unit 54 and stored in a potable water tank or bladder 56. An optionally low pressure output pump 58 delivers that water via discharge valves 62 and the purified water flows out through associated distribution nozzles or other fixtures.

A water purification system as described has multiple elements such as one or more pumps and one or more filters that need to be coupled to one another to draw water from a source, to force water through a filter, to pump purified water into a tank, etc. Depending on the situation, a reverse osmosis filter may be advantageous, for example for desalination. More or less flow volume may be needed per unit of time. Although the elements of a filter installation could be permanently configured and mounted on a truck or trailer to form a self-contained unit, it is advantageous to arrange the system as a number of functional modules that can be coupled in selected configurations. In the embodiment shown, plural osmosis membrane vessels are mounted in an array on a partially enclosing frame and have fittings or manifolds at the ends for coupling the devices and/or their filtered water or brine flowpaths in parallel or series. It is also advantageous at times to stack two or more such membrane racks and likewise to make the necessary parallel and serial connections of the reverse osmosis membrane vessel and/or frames or racks of elements.

The combination of functional elements that is appropriate to a particular deployment can be laid out and interconnected to achieve the pressure and flow conditions that produce required pressure and flow conditions. For example, if additional flow capacity is needed, elements such as the reverse osmosis filter elements on one or more of the frames or racks can be arranged in parallel flow configurations, or re-arranged from serial to parallel flow configurations. If there are considerations as to the distance or elevation between source and users, elements can be arranged at corresponding distances and connected by serially disposed pumps. Various configuration changes are readily made. The modular arrangement makes the system versatile.

It is an aspect of the invention that some configurations that exploit variations in series and parallel couplings include inserting a parallel path that specifically comprises a high pressure water pump driven by a power module and coupled to apply water pressure to a reverse osmosis filter unit. In that configuration, there are plural output legs in parallel. Each output leg has a power module, high pressure pump and reverse osmosis filter unit. Thus the water purification system has at least two of these elements of the plural output legs. Upstream, however, the plural legs are fed with supply water from the same single path, namely from the raw water pump, 44, solids separator and media filter units 46, 52. The upstream units, which operate at relatively lower pressure, present comparatively little flow resistance compared to the reverse osmosis filter units. When operated over their ranges of pressure and flow conditions, the upstream raw water pump 44, and separator units 46, 52 can accommodate a doubling of the water flow rate within that range.

The high pressure pump(s) and reverse osmosis filter(s) also can be operated at different pressure and flow operational conditions. But unlike the low pressure elements 44, 46, 52, the flow rate through the reverse osmosis filter units is determined not only by the pressure differential across the filter element, but also in large part by the proportion of dissolved solids in the raw water. When used for desalination, the high proportion of dissolved solids in the raw water requires that the high pressure pump be operated to obtain a higher pressure differential across the reverse osmosis filter in order to get the same filtered water output flow rate. If the pressure differential is low, more of the feed water will be discharged as brine.

It is normally necessary to select fluid-coupled elements in a water treatment system to operate such that the flow rate of upstream supply elements equals the flow rate of downstream filtration elements. Likewise, the pressure head developed by upstream pumps is advantageously distributed such that the available pressure differential when distributed over the serially coupled elements, applies sufficient pressure differential to place each of the serially coupled elements in an operable range of pressure differential. In the case of the disclosed water purification system, however, the raw water supply pump generally has more than sufficient flow capacity to match the requirements of the high pressure pump and reverse osmosis filter. The separator 46 and media filter units 52 do not restrict flow substantially compared to the reverse osmosis filter.

In the disclosed embodiment, two media filter elements 52 can be provided in parallel along the flow path. These units generally contain a particulate material through which raw water flows after passing through the solids separator 46 for removal of sediment. The particulate material sequesters undissolved solids that remain in the flow. The media filter element does not contribute a substantial restriction to flow, and only one media filter element 52 could be used, as opposed to the two parallel units shown. However the media filter elements 52 require back flushing to rinse out the solids that are captured. By providing two media filter elements 52 it is possible to double the operational time between flushing operations. Alternatively, with suitable valve arrangements, one of the media elements 52 can be connected in line with the high pressure pump 30 and reverse osmosis filter 35, while the other media element 52 is being back-flushed.

The water pump modules used to produce pressure or suction each require a water pump driven by a prime mover such as an internal combustion engine 23, e.g., burning gasoline or other fuel, or an electric or hydraulic motor 25 coupled to a corresponding power source. Conventionally, the prime mover engine or motor is permanently mounted on the same module as the pump and is mechanically coupled to the pump such that power exerted by the prime mover, especially torque to rotate a drive shaft, is coupled to the pump and moves the water. Conventionally, the fluid lines that couple between functional modules can be arranged in different ways but the pump modules have permanently married pumps coupled to motors or engines.

In the embodiment shown in FIG. 1, the respective modules include a separator module 46, two filtration modules 52 for ion exchange, separation of volatiles and the like, a reverse osmosis frame rack with several osmosis membrane vessel, and plural pump modules 44, 22 or 24 and 58 that move the water along. Although the operative pump modules each require a prime mover source of mechanical power and a pump that applies the power to induce pressure and/or flow in the water, according to the disclosed embodiments, at least one of the pump modules 22 or 24 is configured such that the pump assembly of the pump module is readily removable and can be installed readily on an alternative pump module having the same or a different type of prime mover.

According to one aspect, at least two pump modules are provided on frames and can be used interchangeably. One module 24 includes an electric motor prime mover 25. Another module 22 (two of which are shown) includes an internal combustion engine 23. Each of the electric motor carrying module 24 and the internal combustion engine module(s) 22 comprise docking structures, explained in detail below, at which a pump 30 of a standardized assembly configuration can be received and operatively coupled to the prime mover.

At least two modules with alternative prime movers (such as electric motor modules, internal combustion engine modules, and/or combinations of different module types) each comprises a permanent mounting on the respective frame of a module, for a respective one of said motor and engine. The motor or engine presents a detachable shaft coupling for the pump. The module construction comprises a docking arrangement whereby the pump can be received interchangeably and fits in to engage the shaft coupling between the motor or engine and the pump, by rigidly fixing the pump assembly in operative position on the module. The pump is alternatively and interchangeably driven by one of the motor and the engine by installing the pump in the detachable mounting of the module carrying the respective one of said motor and engine.

Osmosis is a net movement of solvent molecules, such as water molecules in this case, through a partially permeable membrane toward a region of higher solute concentration. This occurs because there is a tendency to equalize the solute concentrations on both sides of the partially permeable membrane. The difference in solute concentration equates with a pressure head, termed the osmotic pressure. The osmotic pressure is higher when the difference in solute concentration is higher and lower when the difference is lower. By applying a pressure across the membrane in the opposite direction and greater than the osmotic pressure, the solvent can be caused to move toward the side of less concentration, thereby removing the solute and purifying the solvent at the expense of an expenditure of energy. The high pressure pump module is provided to develop sufficient pressure to force water through a membrane of a reverse osmosis filter element 35, in opposition to the inherent tendency of water to diffuse in the other direction. A rather large and heavy high pressure pump is needed to be capable of developing high pressure, generally up to 1,000 lbs./in² (PSI), for desalinating sea water using a reverse osmosis filter stage, while achieving sufficient flow capacity to serve potable water for a moderate contingent of personnel. Considering all water usage, 20 gallons per day may be needed for each member of a company of 150 to 200 soldiers. Considering uses limited to consumption, cooking and personal hygiene (omitting laundry), the usage may be as low as 8 gal./day. For a company of 150 to 200 soldiers and usage of 8 to 20 gal./day, and given 4 hours out of 24 hours for system maintenance, a purification system flow rate of 60 to 200 gal./hour (about 1 to 3.5 gal./minute). Several companies may share a water purification system, suggesting an appropriate flow rate on the order of 5 to 10 gal./min.

In one embodiment, the high pressure pump can be a Wanner Engineering positive displacement pump operable at 1,750 RPM to pump 8.0 gal./min. at up to 1,000 psi approx. Such a pump weighs 66 lbs.

A water purification system according to the embodiment shown, if configured for a company of soldiers as described, could require a five to ten horsepower (HP) prime mover. Suitable electric motors are available from Baldor and from Siemens, for example, a 7.5 horsepower (5.5 KW), three phase motor nominally operable at 1,765 RPM on 60 Hz power. Such a motor is specified to weigh 166 pounds. The engine is preferably between five and ten horsepower. An exemplary gasoline engine at 7.5 HP is available from Briggs & Stratton. An exemplary diesel engine is available from Yanmar (4.3 KW). Other models and other types of prime movers of similar power output are also applicable. It is desirable to avoid unnecessary duplication of these heavy parts, while also providing for the capability to purify water with a high proportion of dissolved solids (such as sea water), and while providing the necessary flow rate to serve a number of consumers.

The prime movers that interchangeably receive the pump are permanently mounted to their respective module frames in a position to locate the drive shaft of the prime mover (motor or engine) coaxially with the shaft of the pump and to engage their shafts when the pump assembly is mounted in the frame by fitting the base shoe 13 of the pump assembly into the slide receptacle on the base panel and clamping down bars 16 (see, e.g., FIG. 5). The drive shaft of the permanently mounted prime mover and the shaft of the pump carry complementary shaft couplings, shown in FIG. 10, whereby the prime mover is mechanically coupled to turn the pump shaft. Preferably, the prime mover shaft and the pump shaft are directly coupled using coaxial axially-engageable non-round structures that are movable together or apart in the axial direction, and engage rotationally when axially fit together or disengage when axially separated. It is also possible to couple the couple the shafts through a drive train with additional couplings and elements between the prime mover shaft and the driven shaft of the pump. For example, a gear reduction unit (shown in FIG. 10) can be disposed in the drive train between the drive shaft and the pump shaft, in which case the pump shaft is located coaxially with the output of the gear reduction unit.

A suitable shaft coupling that is readily fitted by moving the pump along a line parallel to the pump shaft is the jaw type coupler, which has pin or jaw members on one coupling part, spaced from the rotation axis, and extending parallel to the rotation axis to fit into corresponding openings in a complementary coupling part. An example is a jaw type rotational coupler, such as available from Lovejoy Inc. which has a male disc coupled to one shaft, with axial pins spaced from the rotation axis. The pins are fittable into corresponding openings in an opposed female disc coupled to the other shaft, arranged coaxially with the first shaft in a rotational coupler available from Lovejay, sold as a torsional coupler. In any case, the shaft coupling is engaged and disengaged by manual displacement of the pump assembly along a longitudinal axis. When engaged, the coupled transfers torque from the prime mover to the pump.

In a preferred arrangement, a torsional coupler has a disc for one shaft with three fingers arranged at 120 degree intervals, radially spaced from the axis, that fit into three corresponding holes in a coupling disc for the second shaft. The coupling disc for the second shaft can comprise a stiff elastomer defining the three holes, thereby providing a rotational attachment with some degree of cushioning. The coupling can be located within a protective collar that prevents external items from coming into contact with the coupling or shafts.

According to an aspect of the disclosed embodiments, a base mounting structure is provided for removably and interchangeably mounting the pump to either the module carrying the motor or the module carrying the engine (or alternatively to another prime mover module that is similarly equipped). For this purpose, the base mounting comprises complementary structures affixed to the housing of the pump and to the frame structure of the prime mover module. These structures are configured to allow the pump housing to slide into and dock on the frame structure in a position at which the shaft couplings on the pump shaft and the motor or engine shaft fit together axially and become rotationally affixed so as to transfer torque from the motor or engine to the pump. Likewise, the docking arrangement permits the pump to be extracted and decoupled by withdrawing the pump in a direction parallel to the pump and motor shaft axes.

Reference can be made to FIGS. 3 through 8 for aspects of the docking arrangements, which are provided on each of the alternative prime mover modules, and enable the pump housing to be mounted interchangeably for driving by alternative prime mover modules 22, 24. The prime mover modules each comprise a frame 72 preferably of welded bars, for example of angle iron, stainless steel and/or rectangular aluminum tubing. A mounting panel or base plate panel 17 shown separately from the frame on the right side of FIG. 3 is attached to the frame 72 by bolts, preferably with vibration-damping resilient pads 73 disposed between the frame 72 and the base panel 17. (See FIGS. 6 and 8.) The base panel 17 can comprise a ⅜ inch thick aluminum or stainless steel plate with mounting holes or similar provisions for mounting a prime mover such as an internal combustion engine 23 or other prime mover at a predetermined position on the same base panel 17. The assembly including the pump housing 31 likewise is mounted on the base panel 17 in a complementary position by virtue of the sliding receptacle for the pump assembly, engaging with the prime mover to operate the pump.

In FIG. 3, the parts other than the pump and the engine or motor are shown disassembled. The base plate 17 having the clamping slide 15 is to be mounted in the frame 72, which as shown has pivotable carrying handles at each end. The pump assembly 75 as fully assembled including the pump housing 31 is shown in FIG. 4 from the end having the shaft coupling. FIG. 5a shows the pump housing assembly from the opposite end at which fluid connections with the pump are made, and schematically illustrates docking of the pump housing assembly 75 on the base panel 17, namely by moving the pump assembly in the direction shown such that the flanges of shoe pad 13 are received under the clamping flanges 16. The shoe 13 is moved up to the stop 19 and the bolts on clamping flanges 16 are tightened down to lock the pump assembly in position.

The shoe pad 13 can be bolted to the underside of the pump housing 31, for example through bolt holes in shoe pad 13 shown in FIG. 5b. In the embodiment of FIG. 5b, the clamping flanges 16 are biased by helical springs bearing away from base panel 17. The clamping bolts are received in counterbores and the springs reside around the bolts and bear between the top of the base plate 17 and the ends of the counterbores in the clamping flanges 16. When the bolts are loosened, the flanges are raised from plate 17, providing clearance to move the pump assembly 75, on shoe pad 13, into and out of position as shown in FIG. 5c. Tightening the bolts clamps the laterally protruding flanges of the shoe pad 13 against the base plate 17. The base panel 17 is bolted to the lower rails and cross members of the module frame 72 (see also FIGS. 6-8). Additional locating pins or stubs shown in FIG. 5d next to the bolt heads on the underside of panel 17 can be provided to better fix the lateral position of the clamping flanges 16 that overlie the lateral edges of shoe pad 13 when the pump is moved into operative position. The shoe pad 13 can be axially moved up to the stop 19 on the base panel 17. Alternatively, the axial placement position of the pump assembly 75 relative to the motor or engine 23 can be fixed by moving the pump assembly 75 in the direction of axial engagement of the shaft couplings on the pump shaft and motor or engine shaft respectively, until the shaft couplings bottom out. After the shoe pad 13 of the pump housing assembly 75 is in position, the shoe pad 13 is clamped down against the base panel 17 using bolts, thereby rigidly affixing the pump housing 31 and for driving by motor/engine 23 in an operational condition on the base panel 17.

FIGS. 3 and 4 illustrate that the pump assembly comprises two end plates 82 that are bolted on the axial ends of the pump housing 31, two longitudinal grip bars 83 that extend between and are bolted to the end plates, and one lateral grip bar 84 that is exposed on the fluid connection side of the pump housing. (See also FIG. 8, which shows the parts of the pump assembly with the pump itself omitted for purposes of illustration.) The lateral grip bar 84 can comprise a lateral member welded between end stubs with blind bores, receiving the bolts (not shown) that thread into threaded bores at the ends or the longitudinal grip bars. FIG. 3 additionally shows the shaft coupling 85 and a protective guard 87 that is preferably placed to enclose the axial zone occupied by the coupling 85 when mounted.

The pump assembly end plates 82 and grip bars 83, 84 provide places at which the pump housing can be grasped and manipulated by one or two people as shown in FIGS. 6 and 7. This is advantageous because the pump is relatively heavy (nominally 66 lbs. or about 30 Kg). Moreover, the end plates 82 are bolted against and in thermally conductive contact with the pump housing 42. The end plates 82 provide exposed surfaces at which frictional heat developed by the pump can be dissipated by convection into the air. Normally, frictional heat energy developed by the pump is carried along with the flow of water through the pump. However, the heat dissipating endplates are advantageous in that the maximum temperature of the pump is limited by dissipation of heat energy. Potential thermal damage to the pump is limited or delayed in this way even if the pump should be run dry for a period of time.

The grip bars 83, 84 provided on the pump assembly as shown are coupled to the end plates 83 rather than directly to the pump housing 31. As a result, the grip bars remain cooler than the pump housing and the end plates. This arrangement enables one to grasp the pump assembly 75 by the grips and to manipulate the pump assembly while the pump housing is hot, i.e., without waiting for the pump housing to cool.

In the embodiment shown, the shoe member 13 forms a slide structure on the pump housing assembly 75 that is received in a clamping guide fixture on the base panel 17 between flanged bars 16. It should be appreciated that the gender relationship could be reversed, wherein a similar docking arrangement could be configured with a slide mounted by a standoff distance above the base panel 17, received in a slide clamping receptacle on the pump housing assembly 75. According to these embodiments, a slide shoe 13 is affixed relative to one of the module frame 72 or base panel 17 thereon and a housing 31 of the pump. A complementary guiding receptacle is affixed relative to the other of the module frame 72 and the housing 31 of the pump for receiving the slide. Accordingly, and as shown in FIGS. 6 and 7 it is possible to swing the pump housing assembly 75 into or out of position on the base plate 17 while grasping the longitudinal grip bars 83, to push or pull the pump housing assembly 75 in a direction parallel to the pump rotation axis by grasping the lateral grip bar 84, and generally to move the pump housing 31 into or out of its operative its end position in engagement with the motor/engine 23. When the pump is in its end position the pump housing assembly 75 is clamped or unclamped from attachment between the slide flanges 16 and the slide shoe 13 using a wrench.

In FIG. 8, the pump housing 31 is not shown to simplify the drawing; however the shoe 13 that is part of the pump housing assembly is seen sliding through the space between the receptacle flanges 16 up to the end stop 19 that fixes the axial end position of the pump assembly 75. Bolts are provided to tighten the receptacle flanges 16 down over the shoe 13 and clamp the shoe against the mounting panel 17. For ease of insertion of the shoe 13 when installing the pump housing assembly 75, helical compression springs can be provided on the shafts of the bolts to reside in counter bores in the flange bars, and urge the receptacle flanges 16 upward from the base panel to the extent permitted by the bolts, and thereby to open space for the shoe 13. The bolts are tightened down, thereby compressing the springs as the receptacle flanges 16 are clamped down onto the 13 shoe and rigidly clamp the pump housing assembly 75 to the base panel 17. In this way, the pump is held in position at which the shaft coupling 85 between the pump shaft and the motor/engine shaft is engaged. The process is reversed by loosening the bolts (but not detaching the bolts entirely), whereupon on the compression springs raise the clamping receptacle flanges 16. The pump assembly is then withdrawn in a direction parallel to the pump rotation axis, thus decoupling the fitting that rotationally engages the pump shaft with the motor/engine shaft.

Accordingly, in the illustrated arrangements as described, the pump of a water purification system has a pump housing with a rotatable pump shaft, and further comprises a pump assembly containing the pump housing, including at least a base mounting for removably and interchangeably mounting the pump to one or another of the prime mover modules carrying a motor or engine or other prime mover. The base mounting as described can comprise comprises a slide affixed to one of the module and the pump assembly and a guiding receptacle affixed to the other of the module and the pump assembly, for receiving the slide. Preferably the slide is on the pump housing and the receptacle is on a base plate attached to the frame of the prime mover module.

The pump assembly comprises at least one pump end plate attached to the housing of the pump, and at least one elongated bar extending from the pump end plate on a side of the pump opposite from the base mounting and at a space from the base plate, forming a handle for manipulating the pump assembly. Preferably, the a pump assembly chassis is formed by two pump end plates affixed to opposite ends of the pump housing, in thermally conductive contact with the pump housing, and at least one elongated bar extending between the pump end plates on a side of the pump opposite from the base mounting and at a space from the base mounting plate on the motor/engine model frame, forming a handle for manipulating the pump assembly. The handle is thermally conductively spaced from the pump housing at least by the pump end plate.

As shown in FIG. 4, the pump shaft extends through one of the endplates and carries a rotational coupling that mates with the drive shaft a respective one of the motor and engine. The motor/engine preferably is permanently mounted to the base plate that carries the docking slide for the shoe of the pump. Alternatively, the motor/engine can also be a removable element that can be replaced with a prime mover of the same type or of a different type.

Referring again to FIGS. 1 and 2, the water purification system includes a number of rectilinear frames forming functional modules, each of the frames carrying elements of the water purification system for coupling in series and parallel relations using hoses or other flow conduits that are preferably readily attachable with quick connect fittings. At least two of the frames respectively carrying one or more water filtration elements of different types, and at least one of the frames is a prime mover module carrying a motor or engine for driving the mountable and de-mountable water pump. FIG. 2 shows that the frames advantageously are relatively sized to stack atop and in abutment with one another such that a set of the frames forming an operable system for purification of water fully occupies a rectilinear volume for one of shipment and storage.

Advantageously, individual ones of the frames respectively carry functional water purification elements including at least one low pressure pump, a solids separation element, a chemical filtration element, a high pressure pump prime mover, and a reverse osmosis filtration element. The system is shipped on a pallet complementary to the rectilinear stack of frames, as shown in FIG. 2. Inasmuch as the water pump is configured for selective operational mounting and demounting in a selected one of at least two prime mover modules, the option is presented to ship two prime mover frames that are structured alternatively to receive and operate a pump that is mounted in one of them. Alternatively, the prime mover frames, which are externally the same size, are selectively shipped, one or the other, to a particular site of deployment.

FIG. 9 is an assembly view showing an embodiment configured as described, except at least one additional reverse osmosis water purification path is provided, such that two reverse osmosis outlet paths are operated in parallel, both fed from the same low pressure raw water upstream supply. The modular elements as shown can be supplied as a reconfigurable unit, or the additional pump and reverse osmosis filter unit can be provided as an add-on unit supplied separately. FIG. 10 is a diagram that compares typical flow conditions that can be achieved by multiplying the flow paths provided only in the high pressure pump and reverse osmosis filter section of the water purification system. These arrangements show that by configuring the filter system shown in FIG. 9 to include a second high pressure pump and a second reverse osmosis filter unit, one can nearly double the filtered water output capacity.

Inasmuch as the modular system is provided with at least two power modules for interchangeably driving a high pressure pump (three power modules being shown in FIG. 1), the configuration in FIG. 9 requires only a second high pressure pump, which can be mounted in an otherwise unused power module, and a second reverse osmosis filter element to be supplied from that second high pressure pump.

FIG. 10 illustrates and compares the pressures and flow rates observed in a water filtration configuration shown on the left, having a single reverse osmosis filtration path containing a high pressure pump 30 and a reverse osmosis filter 35, versus a configuration as in FIG. 9, shown on the right in FIG. 10, having two parallel reverse osmosis filtration paths, each containing a high pressure pump 30 and a reverse osmosis filter 35. The second reverse osmosis path is added by providing a second high pressure pump module 23 and reverse osmosis filter module 35, coupled via conduits and tee fittings to the output of one or more media filter modules 52 (two being shown). As discussed above, alternative power elements such as electric motors or internal combustion engines are preferably supplied with the water purification unit and can interchangeably receive a high pressure pump 30. The modification to add the second reverse osmosis leg therefore requires only the addition of an extra high pressure pump 30 and an extra reverse osmosis filter 35 (plus associated conduits and connectors). The potable water production rate, however, is nearly doubled from 4.5 to 8.0 gpm.

In FIG. 11, single and double leg configurations are shown and the pressures and flow rates or flow capacities are typical of operation when purifying sea water (i.e., desalination). The reverse osmosis pressure, typically 1,000 PSI, is about five times the pressure for sea water as for fresh water, to achieve similar potable water production rates.

The primary flow rate limitation in the system is the reverse osmosis filtration path. The high pressure pump is capable of operation over a range of pressures, but the operating point in that range is selected as a function of the concentration of dissolved solids in the water, namely to exceed the osmotic pressure that the solids concentration produces across the reverse osmosis membrane. The flow rate of the high pressure pump is kept at a controlled level. A flow restrictor disposed between the raw water pump 44 and the high pressure pump 30 is adjusted to feed the required flow rate, namely 8 gpm in this example, to each high pressure pump 30 from the raw water pump 44. Accordingly, a raw water flow rate of 16 gpm is provided in the example with two parallel reverse osmosis paths, or 8 gpm in the example with one reverse osmosis.

The difference in flow rate from the raw water pump results in a decreased pressure head from the raw water pump as shown. Part of the pressure head is likewise applied across each of the sediment filter 46, the flow restrictor and the media filter 52. Accordingly, the water pressure at the inlet to the high pressure pumps is somewhat lower in the parallel filtration path configuration, leading to production rate of 4.0 gpm per parallel filtration path. The total potable water production rate achieved from the two parallel filtration paths is 8 gpm or 1.77 times the production rate using the same elements with a single filtration path. This improvement in production rate is achieved without the need for a like increase in the number of elements employed or in the capacities of the elements of the water filtration system.

The near doubling of the production rate using two parallel reverse osmosis filtration paths is achieved with minimal alteration of the single path configuration and is possible because the upstream elements including the raw water pump sediment filters and media filter are operable over a range of pressure and flow conditions. However the added parallel filtration path constitutes a load on the supply such that the flow rate of production water per filtration path is reduced from 4.5 gpm to 4.0 gpm. If one attempted to add one or more further parallel filtration legs, the rate per parallel leg decreases further. Assuming, for example that three parallel legs could produce 3 gpm, the total production of 9 gpm is only marginally better than the 8 gpm produced with two parallel legs. In these circumstances, providing for a configuration with only two parallel legs is practical. Furthermore, adding the second parallel leg may be accomplished by using one of the alternative power modules provided interchangeably to run the high pressure pump.

As thus described, a water purification system comprises a plurality of modules respectively carrying functional water purification elements that are connectable by water flow conduits to one another and to a source of water to be purified. The plurality of modules include at least one module containing a first water filtration element, and at least one module containing at least a first water pump. The first water pump is coupleable between a water source and the water filtration element. The plurality of modules comprise frames on which the functional water purification elements are mounted. The frames of the plurality of modules are relatively sized to stack atop and against one another in abutment of the frames, to fill out a rectilinear volume for compact shipment and storage.

The plurality of modules that fill out the rectilinear volume include at least two power modules that interchangeably receive and drive the at least one water pump for providing the pressure head to the water filtration element. At least a second water pump is coupleable between the water source and at least a second water filtration element. This second pump and second water filtration element form a second parallel path.

The water filtration elements comprise reverse osmosis membranes. Advantageously, the plurality of modules include at least two modules that interchangeably receive and drive the first and second water pump for providing said pressure head to the first and second water filtration element. These two modules can be deployed at the same time such that the two modules drive the first and second water pump, respectively. In this way, providing the plurality of modules with the second pump and the second water filtration element is sufficient to support the two parallel paths, increasing the production flow rate without needing a fully redundant water purification system.

The system including the elements for the second parallel filtration path provide an improvement on a portable water purification system per se, comprising, in combination, a plurality of modules that are serially coupleable to one another by conduits along a path from a source of raw water to an outlet for potable water, the path including a solids separator, a high pressure pump and a reverse osmosis filter element. The portable water purification system comprises at least two power drive units that can interchangeably receive the high pressure pump. The solids separator, the power drive units, the high pressure pump and the reverse osmosis filter unit are packed together as a transportable unit and configurable in a deployment to define a low pressure water source coupled to a first reverse osmosis water purification leg. The improvement comprises a flow capacity extension kit including a second said high pressure pump and a second reverse osmosis filter element configured to be serially coupled into a second reverse osmosis water purification leg in parallel with the first reverse osmosis water purification leg and coupled to the solids separator for sharing the source of raw water.

The plurality of modules comprise frames that are relatively sized to stack atop one another and against one another in direct abutment of the frames. When stacked and abutted, the frames fill out a rectilinear volume for compact shipment and storage.

The foregoing apparatus are useful in practicing a method for purifying water, comprising providing a set of modules and interconnections in a unit, and operably assembling the modules on site, for obtaining supply water from a water source and passing the supply water successively through a solids filter section and a reverse osmosis filtration section. The reverse osmosis section comprises a high pressure pump coupled to a reverse osmosis membrane, producing filtered production water from an output of the solids filter section, through a reverse osmosis filtration path, having a flow rate determined by a concentration of solutes in the supply water and an output pressure of the high pressure pump. At least one additional high pressure pump and at least one additional reverse osmosis membrane are provided together with the modules. By coupling the additional high pressure pump and the additional reverse osmosis membrane, on site, to the output of the solids filter section, two parallel reverse osmosis filtration paths are arranged, both coupled to the output of the same solids filter section, but together purifying water at a sum of flow rates of the parallel reverse osmosis filtration paths.

The invention has been described and disclosed with respect to certain embodiments that are presented as nonlimiting examples. The invention is not limited to the embodiments disclosed as examples. Reference should be made to the appended claims rather than the disclosure of exemplary embodiments, to determine the scope of the invention in which exclusive rights are claimed.

1-9. (canceled)

10. A water purification system, comprising:
a plurality of water purification system elements carried in transportable modules, wherein the water purification system elements are configured for successive water purification steps and are serially connectable to one another by water flow conduits defining a flow path between a source of water to be purified and at least one purified water outlet;
wherein the water purification elements along the flow path include a feed water pump disposed upstream along the flow path and a first water filtration element disposed downstream along the flow path;
wherein the feed water pump has a throughput flow and pressure characteristic, and the first water filtration element has a flow restriction characteristic, configured to provide a given rate of purified water to the at least one purified water outlet;
wherein the feed water pump and the first water filtration element are carried in separate ones of the transportable modules;
wherein the flow and pressure characteristic of the feed water pump is more than sufficient to supply requirements of the first water filtration element;
further comprising at least a second water filtration element in a further separate one of the transportable modules, the second water filtration element likewise having a flow restriction characteristic;
wherein the second water filtration element is selectively coupleable in a parallel configuration with the first water filtration element to provide the given rate in a configuration of the feed water pump feeding only the first water filtration element and an enhanced rate with the feed water pump feeds both the first and second water filtration elements in the parallel configuration.

11. The water purification system of claim 10, wherein the flow and pressure characteristic of the feed water pump is such that the feed water pump has at least twice a flow capacity of the first water filtration element.

12. The water purification system of claim 11, wherein the flow restriction characteristic of the first and second water filtration elements are determined in part by first and second high pressure pumps associated with the first and second water filtration elements, respectively.

13. The water purification system of claim 12, wherein the first and second water filtration elements each comprise a reverse osmosis membrane through which the respective high pressure pump forces water.

14. The water purification system of claim 13, wherein the reverse osmosis membranes of the first water filtration element is arranged to supply a given rate of purified water when supplied with fresh water from the source of water and a lower rate of purified water when supplied with water from the source of water having dissolved solids.

15. The water purification system of claim 12, wherein the reverse osmosis membranes of the first water filtration element is arranged to supply a given rate of purified water when supplied with fresh water from the source of water and a lower rate of purified water when supplied with salt water, and the enhanced rate of purified water when the feed water pump supplies salt water to the first and second water filtration elements in the parallel configuration approximates a rate at which the first water filtration element provides purified water from a fresh water source when the second water filtration element is not coupled in the parallel configuration with the first water filtration element.

16. The water purification system of claim 15, wherein the second water filtration element is provided in a flow capacity extension kit in a respective said distinct separately transportable module.

17. The water purification system of claim 16, wherein the first water purification element is provided in a respective said distinct separately transportable module that is substantially the same as the flow capacity extension kit.

18. The water purification system of claim 12, wherein the first and second water filtration elements are substantially identical framed modules that are useful individually and are connectable in parallel, for purifying water from the feed water pump.

19. A method for purifying water from a source that can have distinctly different levels of total dissolved solids, comprising:
feeding supply water to a first water filtration element from a feed water pump, wherein the first water filtration element contains high pressure pump forcing water from the feed water pump through a reverse osmosis filter membrane and produces a given rate of purified water at a purified water outlet when supplied with feed water, the given rate of purified water being determined in part by flow resistance of the reverse osmosis filter membrane to water supplied by the high pressure pump;
providing the feed water pump with a flow capacity that substantially exceeds a rate needed to operate the first water filtration element to produce the given rate;
increasing a rate of water production by selectively coupling at least a second water filtration element in parallel with the first water purification element such that the first and second water filtration elements are fed in parallel from the feed water pump, the second water filtration element likewise having a high pressure pump forcing water from the feed water pump through a reverse osmosis filter membrane when fed in parallel with the first water filtration element.

20. The method of claim 19, further comprising housing the first and second water filtration elements in transportable modules, and using quick connect couplings to convert a serial flow arrangement from the feed water pump to the first water filtration element in to a parallel arrangement of the first and second water filtration elements fed from the same said feed water pump.

21. The method of claim 19, wherein the first and second water filtration elements are substantially alike and each has a reverse osmosis filter membrane that produces a given rate of purified water from fresh water and a fraction of the given rate from salt water, and further comprising supplying only one of the first and second water filtration elements with fresh water and at least the first and second water filtration elements in parallel, supplied from the same said feed water pump, when changing to a supply of salt water.

22. The method of claim 19, wherein the first and second water filtration elements are housed in substantially identical said transportable modules.

23. The method of claim 19 comprising configuring the feed water pump and the first and second water filtration elements to provide a purified water production rate when operating the first and second water filtration elements in parallel that is at least 80% greater than the given rate provided when operating the feed water pump and the first water filtration element alone.
